(19) United States
(12) Patent Application Publication
(10) Pub. No.: US 2023/0306006 A1
(43) Pub. Date: Sep. 28, 2023

(54) SYSTEM AND METHOD FOR POINT-IN-TIME REVISIONING FOR DATABASES

(71) Applicant: Merydyan Technologies LLC, Appleton, WI (US)

(72) Inventor: Dennis Michael Sheldon, JR., Shawano, WI (US)

(21) Appl. No.: 18/115,705

(22) Filed: Feb. 28, 2023

Related U.S. Application Data
(60) Provisional application No. 63/315,311, filed on Mar. 1, 2022.

(51) Int. Cl. G06F 16/21; G06F 16/242; G06F 11/14; G06F 16/23

(52) U.S. Cl. CPC G06F 16/219; G06F 11/1446; G06F 16/2393; G06F 16/2443

(57) ABSTRACT

A system and method for point-in-time revisioning of a database includes a user database configured to store records related to a gaming environment, a point-in-time (PIT) database configured to revise stored records, a computing system configured to communicate with the PIT database, and an application executable by a processor of a user computing device and to communicate with the computing system, wherein the application is configured to have the processor execute instructions to receive a record to be saved by the PIT database, apply PIT revision of the record to be saved with the PIT database, transmit the revisioned record to be saved to the user database, request the current revision of the saved record by the user, and receive the revised record from the PIT database, and transmit the current revision of the saved record to the user.

### CROSS REFERENCE TO RELATED APPLICATION(S)

The present application claims the benefit of and priority to U.S. Provisional Pat. Application Serial No. 63/315,311, filed Mar. 1, 2022, the entire disclosure of which is hereby expressly incorporated by reference.

### BACKGROUND OF THE INVENTION

### Field of the Invention

The present disclosure relates generally to databases and, more specifically, to a system and method for point-in-time revisioning for databases.

### Description of Related Art

With traditional storage of data in a database, it is not possible to revert changes to a certain point in time or to determine the history of records within the database. Once a change is made, the original state of that record is lost. In that traditional sense, a user must restore from a backup if there is a need to revert to changes in the database. One problem with this approach is that the user can only restore to the point-in-time that the database backup was taken, which typically happens only once, or maybe a handful of times per day.

In gaming environments, it is extremely important to have the necessary audit information to determine how, when, and where changes are being made in a database. One problem with a traditional database is that many extra database tables are required to support capturing this audit information, and the capabilities are limited with regards to rollbacks and data integrity.

In many scenarios, users of the database would need to rollback only a certain module or subset of tables in the database. When relying on a database backup for this purpose, it is not possible to achieve that level of granularity.

Another problem is the concept of archiving and keeping the database as clean as possible.

The present disclosure is aimed at solving one or more of the above-identified problems.

### SUMMARY OF THE INVENTION

The present invention provides a system for point-in-time revisioning of a database including a user database configured to store records related to a gaming environment, a point-in-time (PIT) database configured to revise stored records, a computing system configured to communicate with the PIT database, and an application executable by a processor of a user computing device and to communicate with the computing system. The application is configured to have the processor execute instructions to receive a record to be saved by the PIT database, apply PIT revision of the record to be saved with the PIT database, transmit the revisioned record to be saved to the user database, request the current revision of the saved record by the user, and receive the revised record from the PIT database, and transmit the current revision of the saved record to the user.

The present invention also provides a method for point-in-time revisioning of a database including the steps of storing, in a user database, records associated with a gaming environment, providing a point-in-time (PIT) database to revise stored records to be saved, establishing, by a computing system, communication with the user database, executing, with an application by a processor of a user computing device to communicate with the computing system, wherein the application is configured to have the processor execute instructions receiving, by the PIT database, a record to be saved to the user database, revisioning, by the PIT database, the record to be saved with PIT revisioning, transmitting, by the PIT database, the revisioned record to the user database, requesting, by the user computing device, the current revision of the saved record from the PIT database, and receiving, by the user computing device, the current revision of the saved record from the PIT database, and transmitting, by the PIT database, the current revision of the saved record to a user.

One advantage of the present invention is that a system and method is provided for point-in-time (PIT) revisioning of a database. Another advantage of the present invention is that the system and method can easily revert an entire table, a set of tables, or just a single record to the desired point-in-time. Yet another advantage of the present invention is that the system and method archives and keeps the database as clean as possible. Still another advantage of the present invention is that the system and method, based on the point-in-time capture of every change, archives records automatically to keep the primary tables and indexes as slim as necessary. A further advantage of the present invention is that the system and method captures all changes to data to support point-in-time snapshots, rollbacks, and archiving of stored data. Yet a further advantage of the present invention is that the system and method provide the necessary audit trail information to determine exactly when, where, and by whom database changes were made. Still a further advantage of the present invention is that the system and method, when implementing PIT revisioning, allows a database to be rolled back to an exact second in time without affecting the integrity of the data.

Other advantages and features of the present disclosure will be readily appreciated, as the same becomes better understood, by reference to the subsequent detailed description, when considered in connection with the accompanying drawings.

### BRIEF DESCRIPTION OF THE DRAWINGS

Non-limiting and non-exhaustive embodiments of the present invention are described with reference to the following figures, wherein like numerals refer to like parts throughout the various views unless otherwise specified.

FIG. 1 is a block diagram illustrating an exemplary system for point-in-time revisioning for a database, according to one embodiment of the present invention.

FIG. 2 is a block diagram of a user computing device that may be used with the system shown in FIG. 1.

FIG. 3 is a block diagram of an exemplary application that may be used with the user computing device shown in FIG. 2.

FIG. 4 is a block diagram of an exemplary logic that may be used with the application of FIG. 3.

FIG. 5 is a history of changes to a person record using the logic of FIG. 4.

FIG. 6 is a flowchart of an exemplary method of point-in-time revisioning of a database that may be used with the system shown in FIG. 1.

### DETAILED DESCRIPTION OF THE PREFERRED EMBODIMENT(S)

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an examples” means that a particular feature, structure or characteristic described in connection with the embodiment of example is included in at least one embodiment of the present invention. Thus, appearances of the phrases “in one embodiment”, “in an embodiment”, “one example”, or “an example” in various places throughout this specification are not necessarily all referring to the same embodiment or example. Furthermore, the particular features, structures, or characteristics may be combined in any suitable combinations and/or subcombinations in one or more embodiments or examples. In addition, it should be appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system”. Furthermore, the present invention may take the form of a computer program product embodied in any tangible media or expression having computer-usable program code embodied in the media.

Any combination of one or more computer-usable or computer-readable media (or medium) may be utilized. For example, a computer-readable media may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisional via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The block diagram(s), flow diagram(s), and flowchart(s) illustrate the architecture, functionality, and operation of possible implementations of systems, methods, and computer program products according to various embodiments of the present invention. In this regard, each block in the flowchart, flow diagrams, or block diagrams may represent a module, segment, or portion of code, which includes one or more executable instructions for implementing the specified logical function(s). It will also be noted that each block of the block diagrams, flow diagrams, and/or flowchart illustrations, and combinations of blocks in the block diagrams, flow diagrams, and/or flowchart illustrations, may be implemented by special purpose hardware-based systems that perform the specified functions or acts, or combinations of special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instructions which implement the function/act specified in the flowchart, flow diagram, and/or block diagram block or blocks.

Several (or different) elements discussed below, and/or claimed, are described as being “coupled”, “in communication with”, or “configured to be in communication with”. This terminology is intended to be non-limiting, and, where appropriate, be interpreted to include without limitation, wired and wireless communication using any one or a plurality of suitable protocols, as well as communication methods that are constantly maintained, are made on a periodic basis, and/or made or initiated on an as needed basis.

The present disclosure particularly describes a system and method for point-in-time (PIT) revisioning of a database to capture all changes to data to support point-in-time snapshots, rollbacks, and archiving of stored data. The present disclosure also provides the necessary audit trail information to determine exactly when, where, and by whom database changes were made. It should be appreciated that, when implementing PIT revisioning, a database can be rolled back to an exact second in time without affecting the integrity of the data.

In the present disclosure, PIT revisioning is applied at the database level of an application and abstracts the view for users and developers. The present disclosure allows a novice user to interact with a database implementing PIT revisioning without knowledge that the PIT revisioning is in place. The present disclosure also allows a developer, on the other hand, to leverage PIT revisioning for more advanced functions, such as rollback, auditing, and archiving of data. It should be appreciated that applications built on a PIT revisioning database do not need to implement any special functionality and can interact with the views and stored procedures as they would with a non-PIT database. It should also be appreciated that, if an application needs to implement the advanced features of PIT, it can do so by referencing data in the History views and interacting directly with the database tables.

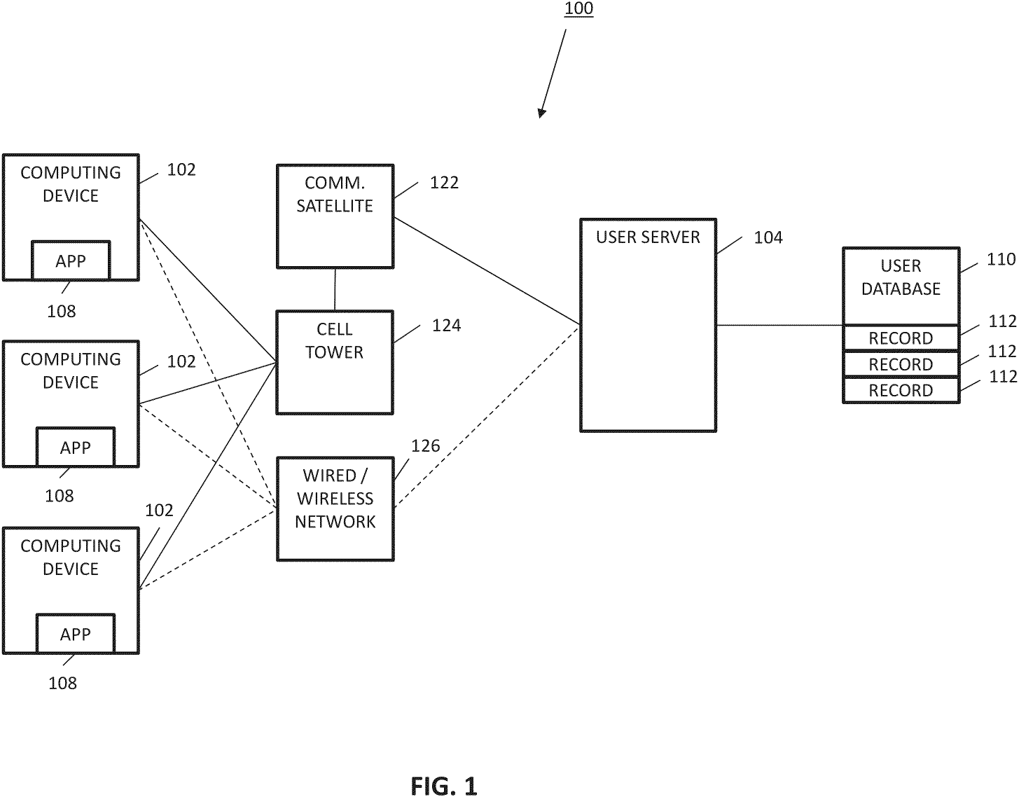

FIG. 1 is a block diagram of an exemplary system 100 that may be used for point-in-time revisioning of a database. In one embodiment, the system 100 includes one or more user computing devices 102 and a user server 104. The various components of the system 100 may be connected together by one or more wired or wireless networks. Although four user computing devices 102 are illustrated in FIG. 1, the system 100 may include any suitable number of the user computing devices 102. Also, while the system 100 is illustrated with the above components, it should be appreciated that one or more components of the system 100 may be combined together or split apart while remaining within the scope of the disclosure. It should also be appreciated that the user computing devices 102 illustrated are for a gaming operator, gaming regulator, gaming supplier, and test lab.

The user computing device 102 is a computing device that may be operated by a user to access a user database 110. The user computing devices 102 may include a mobile phone, a personal digital assistant (PDA), a tablet computer, a wearable computing device, a laptop computer, a desktop computer, a kiosk, a point-of-sale terminal, a virtual reality device, an augmented reality device, or any other suitable computing device that enables the user computing device 102 to operate as described herein. In one embodiment, an application or “app” 108 is installed on each user computing device 102 to enable the user to access the database 110.

The user server 104 is a computing device that enables multiple user computing devices 102 to access the database 110. In one embodiment, the user server 104 stores user information for each user in a user database 110 and gaming information from a gaming establishment such as a casino in the user database 110. The user information may be stored in a plurality of records 112 in the user database 110. The records 112 may include a username, a user password, and/or any other suitable information or record. The user server 104 may retrieve the records 112 from the user database 110 by querying the user database 110 during operation.

In one embodiment, the system 100 includes devices that enable the user computing devices 102 to transmit and receive data to and from the user server 104. The devices may include one or more communication satellites 122, one or more cellular towers 124, and devices forming one or more wired or wireless networks 126. In one embodiment in which the user computing devices 102 are cellular phones, the user computing devices 102 may communicate with the user server 104 by transmitting signals to the cellular tower 124 which then transmits the signals to the communication satellite 122. The communication satellite 122 transmits the signals to the user server 104. In turn, the user server 104 may transmit signals to the user computing devices 102 in the reverse direction via the communication satellite 122 and the cellular tower 124. It should be appreciated that the user computing devices 102 may communicate with the user server 104 via one or more wired or wireless networks 126, such as the Internet.

In one embodiment, the signals transmitted between the user computing devices 102 and the user server 104 are encrypted using a suitable encryption algorithm. For example, the signals may be encrypted using a public key infrastructure (PKI) algorithm. In another embodiment, the signals may be encrypted using any suitable algorithm.

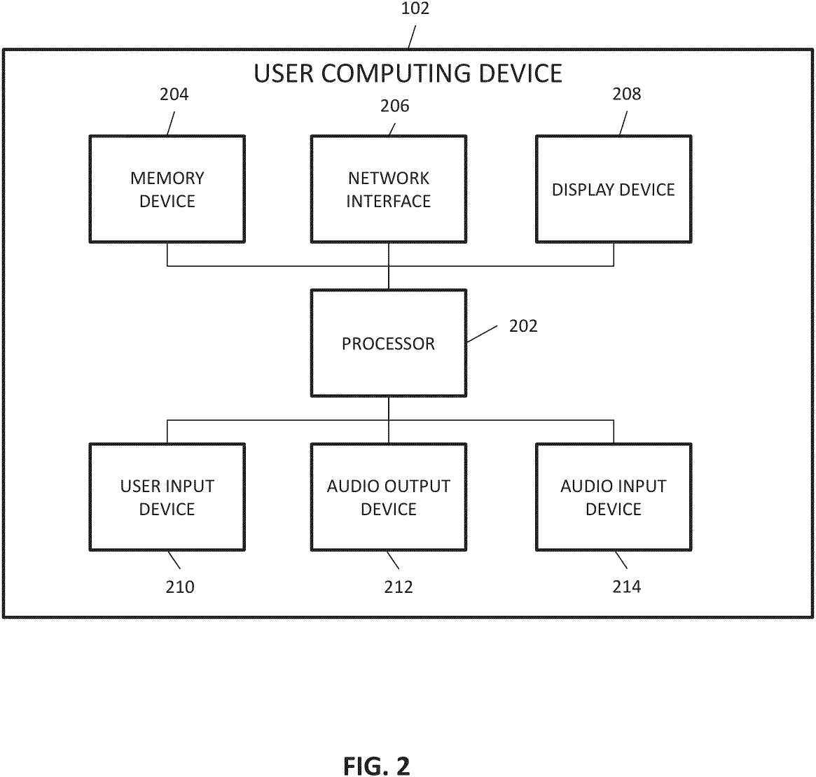

FIG. 2 is a block diagram of one embodiment of the user computing device 102 that may be used with the system 100 (shown in FIG. 1). However, it should be appreciated that one or more components of the system 100 may not be included in the user computing device 102 such as the user server 104.

In one embodiment, the user computing device 102 includes a processor 202, a computer-readable memory device 204, and a network interface 206. In one embodiment, the user computing device 102 may also include a display device 208, a user input device 210, an audio output device 212, and/or an audio input device 214. It should be appreciated that the memory device 204, network interface 206, display device 208, and user input device 210 (if provided) may be connected to the processor 202 and/or to each other via any suitable bus or busses, interfaces, or other mechanisms.

The processor 202 includes any suitable programmable circuit including one or more microcontrollers, microprocessors, application specific integrated circuits (ASICs), systems on a chip (SoCs), programmable logic circuits (PLCs), field programmable gate arrays (FPGAs), and/or any other circuit capable of executing the functions described herein. The above examples are exemplary only, and thus are not intended to limit in any way the definition and/or meaning of the term “processor.”

The memory device 204 is an electronic storage device that includes one or more non-transitory computer readable medium, such as, without limitation, random access memory (RAM), flash memory, a hard disk drive, a solid-state drive, a compact disc, a digital video disc, and/or any suitable memory. The memory device 204 may include data as well as instructions that are executable by the processor 202 to program the processor 202 to perform the functions described herein. For example, the methods described herein may be performed by one or more processors 202 executing instructions stored within one or more of the memory devices 204.

The network interface 206 may include, without limitation, a network interface controller (NIC) or adapter, a radio frequency (RF) transceiver, a public switched telephone network (PSTN) interface controller, or any other communication device that enables the user computing device 102 to operate as described herein. In one embodiment, the network interface 206 may connect to the network interfaces 206 of the other user computing devices 102 of the system 100 through a network using any suitable wireless or wired communication protocol.

The display device 208 may include, without limitation, a liquid crystal display (LCD), a vacuum fluorescent display (VFD), a cathode ray tube (CRT), a plasma display, a light-emitting diode (LED) display, a projection display, a display integrated into a virtual reality or augmented reality device, and/or any suitable visual output device capable of displaying graphical data and text to a user. For example, the display device 208 may be used to display a graphical user interface associated with the application 108 to the user.

The user input device 210 may include, without limitation, a keyboard, a keypad, a touch screen, a mouse, a scroll wheel, a pointing device, a video input device that registers movement of a user (e.g., usable with an augmented reality input device or a virtual reality input device), and/or any other suitable device that enables the user to input data into the user computing device 102 and/or retrieve data from the user computing device 102.

The audio output device 212 may include, without limitation, one or more speakers or any other device that enables content to be audibly output from the computing device 200. For example, music or other audio content associated with one or more games may be audibly output from the audio output device 212.

The audio input device 214 may include a microphone or another suitable device that enables the user to input audio commands into the user computing device 102. The audio input device 214 may employ speech recognition software to convert spoken commands from the user into digital data for use in operating the user computing device 102.

While the foregoing components have been described as being included within the user computing device 102, it should be appreciated that at least some of the user computing devices 102 may not include each component. For example, a server may not include the audio output device 212, audio input device 214, user input device 210, and/or display device 208. In addition, the user computing device 102 may include any suitable number of each individual computing device component. For example, the user computing device 102 may include a plurality of the processors 202 or processor cores, a plurality of the memory devices 204 (of the same or different types, sizes, etc.), and/or a plurality of the display devices 208.

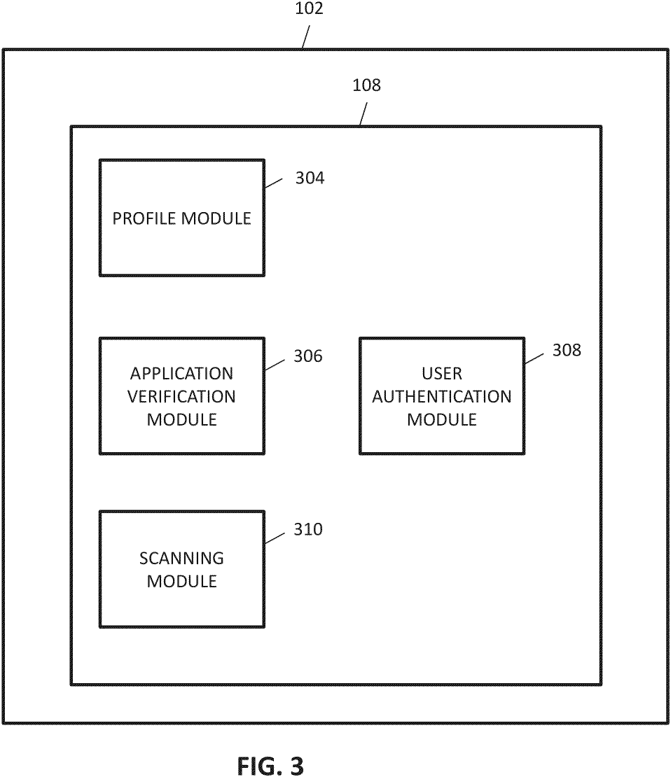

FIG. 3 is a block diagram of an exemplary application 108 that is executable on the user computing device 102 (shown in FIG. 2) and that may be used with the system 100 (shown in FIG. 1). In one embodiment, the user computing device 102 may include a plurality of modules that may be embodied as one or more software modules within the application 108. In another embodiment, each module may include firmware and/or hardware components in addition to, or instead of, the software components within the application 108. The modules may include, for example, a profile module 304, an application verification module 306, a user authentication module 308, and a scanning module 310.

The profile module 304 is a module that stores user information such as username, full name, email address, password, and telephone number that is personal to the user. The profile module 304 may be used to display the profile of a user to another user.

The application verification module 306 may be executed by the processor 202 to verify the integrity of the application 108 to the user server 104. For example, when the processor 202 uses the application 108 to initiate a connection with the user server 104, the user server 104 may request application integrity or verification information from the application verification module 306 to ensure that the application 108 has not been tampered with or otherwise altered in an unauthorized manner. Accordingly, the application verification module 306 may calculate and store a digital fingerprint of the application 108, such as by executing a hash algorithm on the files of the application 108. The resulting application fingerprint may be stored in the application verification module 306 (or another suitable portion of the memory device 204) and may be transmitted to the user server 104 in response to receiving an application verification or integrity request from the user server 104. The user server 104 may compare the application fingerprint to a reference fingerprint stored on the user server 104 to verify the application fingerprint (and thus the application 108). If the application fingerprint matches the reference fingerprint, the application 108 (and by extension, the user computing device 102) may be verified and may be allowed to access the user server 104 to place wagers, for example.

The user authentication module 308 may be executed by the processor 202 to authorize a user to access the application 108 on the user computing device 102 and/or to access the user server 104 using the user computing device 102. For example, when a user opens or accesses the application 108 using the user computing device 102, the user authentication module 308 may prompt the user to enter a username and password, or another suitable access key such as a fingerprint or secure key fob, to access the application 108 and/or to log in to the user server 104. The user authentication module 308 may transmit a connection request to the user server 104 with the username and password (or other access key) entered by the user. The account server 104 may compare the username and password (or a fingerprint of either or both) to a stored record 112 containing the correct username and password of the user. If the username and password are correct, the user server 104 may enable the application 108 (and the user computing device 102) to access the user database.

The scanning module 310 may be executed by the processor 202 to capture an image of a user identification document, such as a passport or driver’s license. The image may be stored in the scanning module 310 (or another suitable portion of the memory device 204) and may be transmitted to the account server 104 to enable the user to sign up for an account. The scanning module 310 may also capture an image of the user’s face for identification purposes, and/or may capture an image of a barcode or the like.

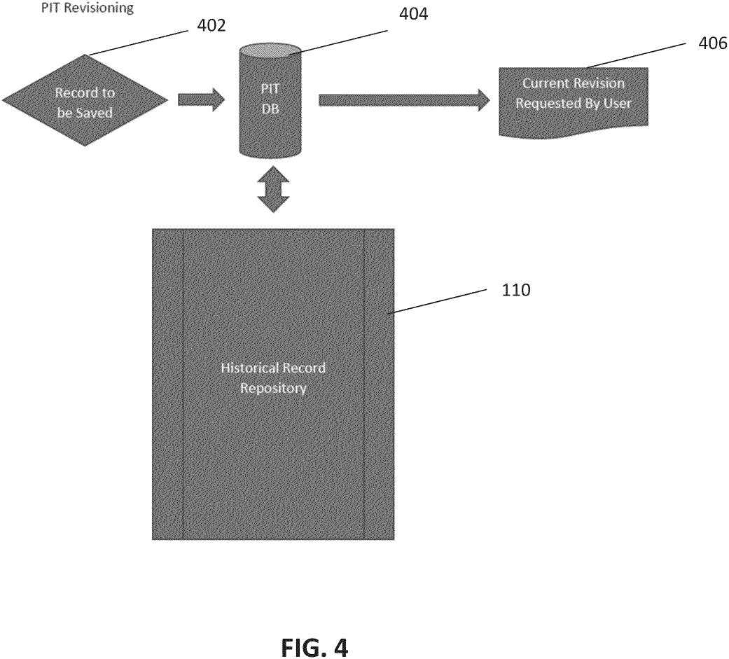

Referring to FIG. 4, a point-in-time (PIT) database 404 is shown. The PIT database 404 is a database table built upon a set of well-known columns, two views, one view for current revision of all records and one view for all PIT history, and two stored procedures, one procedure for saving data and one procedure for selecting data. All changes made to records implement the save stored procedure, which handles the primary PIT revisioning logic. When implemented, the PIT database 404 saves a record of all changes, time stamped with the current UTC date and time, along with the Identification (Id) of the user requesting the change. The PIT database 404 assigns each change a revision number and a unique Id. It should be appreciated that the first revision of a record will always be where the current state of the record can be found, with all subsequent changes being stored as a new revision within the same table.

As illustrated, the user database 110 is a historical record repository. In operation, a record to be saved 402 is transmitted either by the user server 104 or the user computing device 102 to the PIT database 404. The PIT database 404 communicates with the user database 110 to transmit and receive records saved. If a current revision is requested by a user, the user database 110 transmits the saved record to the PIT database 404, which, in turn, transmits the current revision requested by the user to the user computing device 102 or the user server 104.

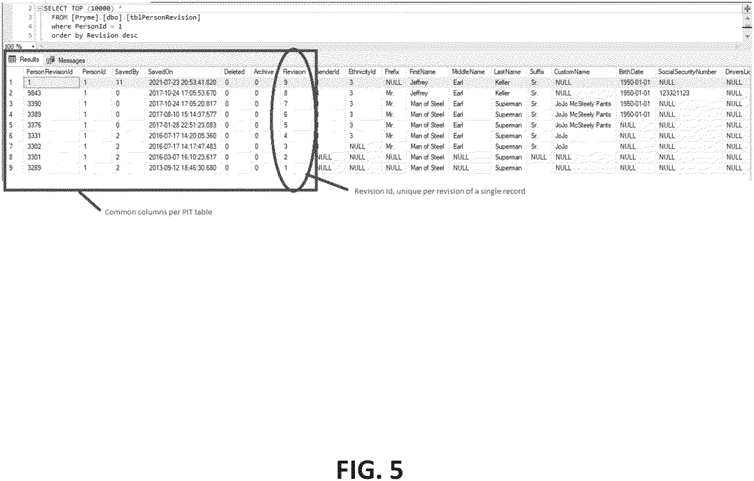

For example, as shown in FIG. 5 and described below, there is disclosed the history of changes to the person record of Jeffrey Keller. This data is shown in descending order by Revision Id, with the current revision at the top. It should be appreciated that the current revision has an Id column (in this case Person Id) and a Revision Id column (in this case Person Revision Id) with the same value. It should also be appreciated that this is how PIT revisioning knows which records to be considered as current and present within views.

In the PIT database 104, the stored procedures and views abstract the view into the data and simplify the interface for users and developers. The default PIT view will only present the current revisions for all records and the stored procedure for selecting records will typically operate on this view. To save a change to a record, or even a new record, the user or developer only needs to present the current data and the record Id. The save stored procedure will then determine if a new record or an update is being saved and create the appropriate revisions.

To determine what a record looked like at a given point in time, a simple select statement from the History view, such as this, would yield the necessary results.

$$\begin{matrix}\text{SELECT * FROM vwPersonHistory WHERE PersonId=1 AND ‘2018-01-23} \\ \text{21:02:15} \text{.000’ BETWEEN RevisionStartsOn AND RevisionEndsOn}\end{matrix}$$

To implement the PIT revisioning with the PIT database 404, these standard columns must be added to any table that needs PIT functionality (using Person table as an example):

| | | |
|---|---|---|
| [PersonRevisionId] | INT | NOT NULL IDENTITY(1,1) |
| [PersonId] | INT | NOT NULL DEFAULT 0 |
| [SavedBy] | INT | NOT NULL |
| [SavedOn] | DATETIME | NOT NULL DEFAULT |
| GETUTCDATE(), | | |
| [Deleted] | BIT | NOT NULL DEFAULT 0 |
| [Archive] | BIT | NOT NULL DEFAULT 0 |
| [,Revision] | SMALLINT | NOT NULL DEFAULT 1 |

Additionally, this trigger and index must be added to the table:

--Each revision of an entity should be unique.
CREATE UNIQUE NONCLUSTERED INDEX
[UK_tb1PersonRevision_PersonId_Revision]
ON [dbo].tb1PersonRevision([PersonId],[Revision]) WHERE [PersonId] <> 0
GO
CREATE TRIGGER [dbo].[TR_tb1PersonRevision_AfterInsert] ON
[dbo].[tblPersonRevision] AFTER INSERT
AS
BEGIN
SET NOCOUNT ON
--Backfill the current revision ID after the revision ID for the first revision is
available
UPDATE [tblPersonRevision] SET [Personld]=[PersonRevisionld] WHERE
[PersonId]=0
END
GO

Finally, the views and stored procedures interface upon the above table and must follow the standards laid out within each. It should be appreciated that the PIT selects stored procedures also support server-side paging, and if implemented by a select stored procedure, the methods for applying that concept are followed as laid out in the stored procedure (procPeopleSelect).

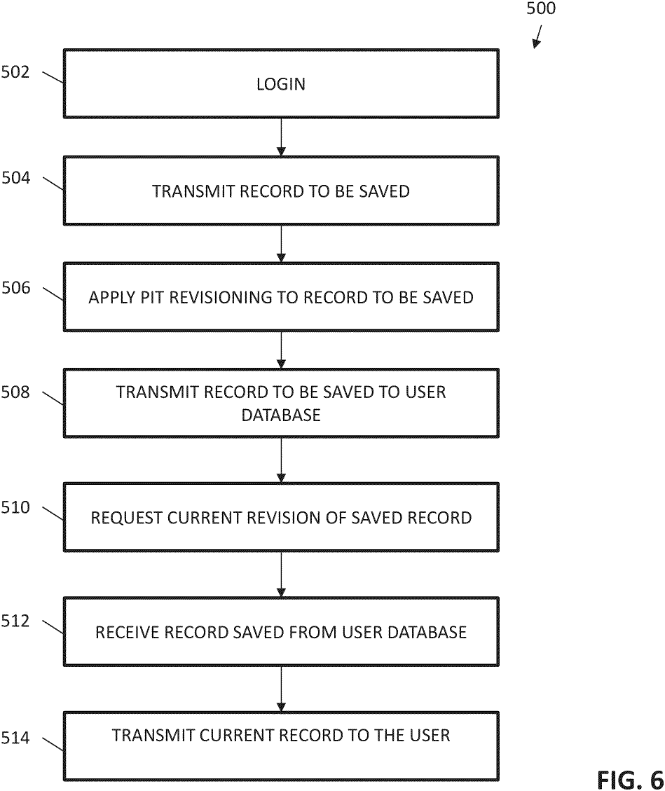

FIG. 6 is a flow diagram of an exemplary method 500 of point-in-time revisioning of the database 110, such as for gaming, that may be used with the system 100 (shown in FIG. 1). While the method 500 is described with reference to a point-in-time revisioning of a database for gaming, it should be appreciated that the method 500 may be used with any suitable database and the like. The method 500 may be implemented by the user computing device 102 with the app 108 or the user server 104 (shown in FIG. 1), such as by the processor 202 of the user computing device 102, and user server 104 executing computer-readable instructions stored within the memory device 204 of the user computing device 102 and user server 104. In another embodiment, the method 500 may be implemented by any suitable device of the system 100.

In one embodiment, the method 500 is an algorithm that includes the step 502 of logging in by a user of the user computing device 102 of a user application (or app), such as the application 108, to access the database 110. For example, a user may use a cellular phone to access the application 108 to access the database. The method 500 includes the step 504 of transmitting a record to be saved 402 either by the user server 104 or the user computing device 102 to the point-in-time (PIT) database 404. The method includes the step 506 of applying PIT revisioning with the PIT database 404 to the record to be saved. The method includes the step 508 of transmitting the revised record to the user database 110 by the PIT database 404. The method includes the step 510 of requesting a current revision of saved record of a user. The method includes the step 512 of transmitting, by the user database 110, the saved record to the PIT database 404 and receiving the current revision by the PIT database 404. The method includes the step 514 of transmitting, by the PIT database 404, the current revision requested by the user to the user computing device 102 or the user server 104.

Although specific features of various embodiments of the disclosure may be shown in some drawings and not in others, this is for convenience only. In accordance with the principles of the disclosure, any feature of a drawing or other embodiment may be referenced and/or claimed in combination with any feature of any other drawing or embodiment.

This written description uses examples to describe embodiments of the disclosure and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for point-in-time revisioning of a database comprising:
a user database configured to store records related to a gaming environment;
a point-in-time database configured to revise stored records;
a computing system configured to communicate with the PIT database; and,
an application executable by a processor of a user computing device and to communicate with the computing system, wherein the application is configured to have the processor execute instructions to:
receive a record to be saved by the PIT database;
apply PIT revision of the record to be saved with the PIT database;
transmit the revisioned record to be saved to the user database;
request the current revision of the saved record by the user; and
receive the revised record from the PIT database and transmit the current revision of the saved record to the user.

2. The system as set forth in claim 1, wherein the PIT database is configured with a set of predetermined columns and two views.

3. The system as set forth in claim 2, wherein the two views comprise one for current revision of all records and one for all point-in-time history.

4. The system as set forth in claim 1, wherein the PIT database is configured to have a plurality of stored procedures.

5. The system as set forth in claim 4, wherein the stored procedures comprise one for saving the record and one for selecting the record.

6. The system as set forth in claim 1, wherein the PIT database implements changes made to record the save stored procedure.

7. The system as set forth in claim 6, wherein the PIT database saves a record of all changes, time stamped with the current UTC date and time, along with the Id of the user requesting the change.

8. The system as set forth in claim 7, wherein the PIT database assigns each change to a record with a revision number and a unique Id.

9. The system as set forth in claim 8, wherein a first revision of the record will always be where the current state of the record can be found and all subsequent revisions of the record being stored as a new revision of the record within the same table.

10. A method for point-in-time revisioning of a database comprising the steps of:
storing, in a user database, records associated with a gaming environment;
providing a point-in-time (PIT) database to revise stored records to be saved;
establishing, by a computing system, communication with the PIT database;
executing, with an application by a processor of a user computing device to communicate with the computing system, wherein the application is configured to have the processor execute instructions:
receiving, by the PIT database, a record to be saved to the user database;
revisioning, by the PIT database, the record to be saved with PIT revisioning;
transmitting, by the PIT database, the revisioned record to the user database;
requesting, by the user computing device, the current revision of the saved record;
receiving, by the user computing device, the current revision of the saved record from the PIT database; and
transmitting, by the PIT dataset, the current revision of the saved record to a user.

11. The method as set forth in claim 8, including the step of configuring the PIT database to have a set of predetermined columns and two views.

12. The method as set forth in claim 11, wherein the two views comprise one for current revision of all records and one for all point-in-time history.

13. The method as set forth in claim 10, including the step of configuring the PIT database to having a plurality of stored procedures.

14. The method as set forth in claim 13, wherein the stored procedures comprise one for saving and one for selecting.

15. The method as set forth in claim 14, including the step of implementing, by the PIT database, changes made to saved records with the saving stored procedure.

16. The method as set forth in claim 10, including the step of saving, by the PIT database, a record of all changes, time stamped with the current UTC date and time, along with the Id of the user requesting the change.

17. The method as set forth in claim 16, including the step of assigning, by the PIT database, each change a revision number and a unique Id.

18. The method as set forth in claim 13, wherein the first revision of a record will always be where the current state of the record can be found and all subsequent revisions of the record being stored as a new revision within the same table.
